(19) United States
(12) Patent Application Publication
(10) Pub. No.: US 2003/0065580 A1
(43) Pub. Date: Apr. 3, 2003

(54) Sales promotion support system and method

(75) Inventors: Akihiko Obata, Kawasaki (JP); Satoko Segawa, Kawasaki (JP)

Correspondence Address: STAAS & HALSEY LLP, 700 11TH STREET, NW, SUITE 500, WASHINGTON, DC, 20001, US

(73) Assignee: FUJITSU LIMITED, Kawasaki (JP)

(21) Appl. No.: 10/051,125

(22) Filed: Jan. 22, 2002

(30) Foreign Application Priority Data
Oct. 2, 2001 (JP) 2001-306637

(51) Int. Cl. G06F 17/60

(52) U.S. Cl. 705/26

(57) ABSTRACT

There is provided a sales promotion support method in an on-line shopping environment in which a goods provider server used by a goods provider that provides goods is connected to a user terminal used by a user through a communication path, wherein the goods provider server registers information on a user, presents information on goods to a user, manages service points to be given on the registered user basis, and in the case of detecting that a first user that has browsed through information on goods at a user terminal has distributed information on goods to a second user, updates service points of the first user that is a distribution origin.

### BACKGROUND OF THE INVENTION

1. Field of the Invention

The present invention relates to a sales promotion support system and method for promoting distribution of word-of-mouth information in an on-line shopping environment using the Internet or the like.

2. Description of the Related Art

Along with the rapid spread of a communication environment such as the Internet to general consumers in recent years, an on-line shopping environment using the Internet or the like is also being established rapidly. In such an on-line shopping environment, in order to urge eagerness for purchase of consumers, various methods have been considered.

For example, JP 11(1999)-312274 discloses service in which a consumer attaches an electronic discount ticket (numbers and the like representing a discount type, a discount price, an effective period, and the like as electronic signature) issued by a goods provider to electronic mail or the like when transmitting an order signal, whereby a payment can be made in an amount with a specified discount price subtracted therefrom after the goods provider confirms use conditions and the like of the electronic discount ticket. Such service is considered to be electronized discount service, which has been conducted using a coupon in the past.

According to the above-mentioned method, consumers cannot enjoy merits of discount service unless they actually purchase goods. This may be sufficient in general commercial transaction; however, it is not sufficient on an on-line shopping environment.

More specifically, in an on-line shopping environment, information plays an important role, and in order for consumers to conduct advantageous purchase activities, it is important for them to know which goods are being provided at which shops at which prices early and exactly. In order to promote distribution of such information, it is known that larger effects are brought about synergistically by allowing consumers to freely exchange word-of-mouth information through electronic mail and the like, instead of allowing a goods provider to control such communication.

However, according to the conventional method, electronized coupon and the like are not attached to word-of-mouth information exchanged through electronic mail and the like. Therefore, even if incentive for purchase of goods can be given, no incentive can be given for distributing information on goods to a third party on a network.

### SUMMARY OF THE INVENTION

Therefore, with the foregoing in mind, it is an object of the present invention to provide a sales promotion support system and method capable of providing a user with incentive for an action of distributing word-of-mouth information to a third party.

In order to achieve the above-mentioned object, in a sales promotion support system of the present invention in an on-line shopping environment in which a goods provider server used by a goods provider that provides goods is connected to a user terminal used by a user through a communication path, the goods provider server includes: a user information registering part for registering information on the user; a goods information presenting part for presenting information on goods to the user; a service point managing part for managing service points given on a basis of a user registered in the user information registering part; and a goods information distribution detecting part for detecting that a first user having browsed through the information on goods at the user terminal has distributed the information on goods to a second user, wherein, in a case where it is detected by the goods information distribution detecting part that the information on goods has been distributed to the second user, the service points of the first user are updated in the service point managing part.

Because of the above-mentioned configuration, an incentive such as provision of service points can be given with respect to distribution of information on goods between users through electronic mail or the like, which promotes distribution of information on goods. As a result, a purchase chance by a third party can be increased.

In order to achieve the above-mentioned object, in a sales promotion support system of the present invention in an on-line shopping environment in which a goods provider server used by a goods provider that provides goods is connected to a user terminal used by a user through a communication path, the goods provider server includes: a user information registering part for registering information on the user; a goods information presenting part for presenting information on goods to the user; a service point managing part for managing service points given on a basis of a user registered in the user information registering part; and a goods information access detecting part for detecting that a second user has accessed the goods provider server, based on the information on goods distributed to the second user by a first user having browsed through the information on goods at the user terminal, wherein, in a case where it is detected by the goods information access detecting part that the second user has accessed the goods provider server based on the information on goods distributed from the first user, the service points of the first user having distributed the information on goods are updated in the service point managing part.

Because of the above-mentioned configuration, an effective incentive can be given in the case where access such as browsing is actually conducted with respect to information on goods through received mail, as well as in the case where information on goods is distributed between users through electronic mail or the like. Therefore, distribution of information on goods can be promoted, and a purchase chance by a third party can be increased.

Furthermore, in the sales promotion support system of the present invention, it is preferable that when the service points of the first user are updated in the service point managing part, the service points of the second user are simultaneously updated in the service point managing part. In this case, an incentive can be given not only to a distribution origin of information on goods but also to a distribution destination by using service points. Therefore, it is expected that a desire for member registration of a distribution destination user is enhanced, and a purchase chance is actually increased.

Furthermore, in the sales promotion support system of the present invention, it is preferable that the information on goods contains information allowing the first user to be confirmed as a distribution origin. This is because such information is required for providing service points and confirming a distribution path.

Furthermore, in the sales promotion support system of the present invention, it is preferable that a user identifier specific for a user is provided, and the information allowing the first user to be confirmed as a distribution origin contains the user identifier. Furthermore, in the sales promotion support system of the present invention, it is preferable that a goods identifier specific for goods is provided, and the information on goods contains the goods identifier. This is because an unauthorized action for attempting to increase service points by using a user identifier or a goods identifier created without authorization can be prevented in advance.

Furthermore, it is preferable that the sales promotion support system of the present invention further includes a goods information distribution storing part for storing the user identifier of the first user, the user identifier of the second user, and the goods identifier, when the first user distributes the information on goods to the second user, wherein regarding second and subsequent distributions having the same identifiers as the user identifier of the first user, the user identifier of the second user, and the goods identifier stored in the goods information distribution storing part, the service points are not updated. This is because even in the case where an unauthorized action of repeatedly distributing information on the same goods to the same user is conducted, update of service points can be prevented in advance.

Furthermore, it is preferable that the sales promotion support system of the present invention further includes a goods information access storing part for storing the user identifier of a user having accessed the information on goods and the goods identifier so that they are associated with each other, wherein regarding the second user whose user identifier has already been stored in the goods information access storing part with respect to a predetermined goods identifier, the service points are not updated. Because of this configuration, service points will not be given to a second user having already accessed information on goods.

Furthermore, it is preferable that the sales promotion support system of the present invention further includes a user authentication procedure part for authenticating whether or not the user has already been registered in the user information registering part, wherein the service points are updated only with respect to a user confirmed to be registered in the user authentication procedure part. Because of this configuration, the user cannot obtain an incentive without authorization by distributing information on goods to another mail address of the user himself/herself. Examples of a user authentication procedure include presentation of a driver's license, a health insurance certificate, a passport, and the like, and an authentication procedure by biometric authentication or the like.

Furthermore, in the sales promotion support system of the present invention, it is preferable that in a case where a third user accesses the information on goods browsed through by the first user via one or a plurality of the second users, a distribution path in which the information on goods is distributed from the first user to the third user is derived based on distribution information in the goods information distribution storing part, and the service points are updated with respect to the second user present in the distribution path. Since an incentive is also given to a user in some midpoint of the distribution path, distribution of information on goods can be promoted.

Furthermore, the present invention is characterized by software for executing the above-mentioned sales promotion support system as processing operations of a computer. More specifically, the present invention relates to a sales promotion support method in an on-line shopping environment in which a goods provider server used by a goods provider that provides goods is connected to a user terminal used by a user through a communication path. The goods provider server includes: registering information on the user; presenting information on goods to the user; managing service points given on a basis of a registered user; and detecting that a first user having browsed through the information on goods at the user terminal has distributed the information on goods to a second user, wherein, in a case where it is detected that the information on goods has been distributed to the second user, the service points of the first user are updated. The present invention also relates to a computer-readable recording medium storing a program executable by a computer for implementing the above-mentioned operations.

Because of the above-mentioned configuration, a sales promotion support system can be realized, in which the above-mentioned program is loaded onto a computer, whereby an incentive such as provision of service points can be given with respect to distribution of information on goods between users through electronic mail or the like, which promotes distribution of information on goods, and increases a purchase chance by a third party.

Furthermore, the present invention is characterized by software for executing the above-mentioned sales promotion support system as processing operations of a computer. More specifically, the present invention relates to a sales promotion support method in an on-line shopping environment in which a goods provider server used by a goods provider that provides goods is connected to a user terminal used by a user through a communication path. The goods provider server includes: registering information on the user; presenting information on goods to the user; and managing service points given on a basis of a registered user; and detecting that the second user has accessed the goods provider server based on the information on goods distributed from the first user having browsed through the information on goods at the user terminal to the second user, wherein, in a case where it is detected that the second user has accessed the goods provider server based on the information on goods distributed from the first user, the service points of the first user having distributed the information on goods are updated. The present invention also relates to a computer-readable recording medium storing a program executable by a computer for implementing the above-mentioned operations.

Because of the above-mentioned configuration, a sales promotion support system can be realized, in which the above-mentioned program is loaded onto a computer, whereby an effective incentive can be given in the case where access such as browsing is actually conducted with respect to information on goods through received mail as well as in the case where information on goods is distributed between users, which promotes distribution of information on goods, and increases a purchase chance by a third party.

In the sales promotion support method and computer-readable recording medium storing a program executable by a computer for implementing the operations of the method according to the present invention, it is preferable that when service points of a first user are updated, service points of a second user are also updated simultaneously. Since an incentive is given to a distribution origin of information on goods as well as a distribution destination by using service points, a desire for member registration of a distribution destination user is enhanced, and a purchase chance is actually increased.

These and other advantages of the present invention will become apparent to those skilled in the art upon reading and understanding the following detailed description with reference to the accompanying figures.

### BRIEF DESCRIPTION OF THE DRAWINGS

FIG. 1 shows a configuration of a sales promotion support system of Embodiment 1 according to the present invention.

FIG. 2 illustrates a data configuration of a user information storing part in the sales promotion support system of Embodiment 1 according to the present invention.

FIG. 3 illustrates a data configuration of a goods information storing part in the sales promotion support system of Embodiment 1 according to the present invention.

FIG. 4 illustrates a data configuration of a service point storing part in the sales promotion support system of Embodiment 1 according to the present invention.

FIG. 5 is a flow chart showing processing in a goods provider server of the sales promotion support system of Embodiment 1 according to the present invention.

FIG. 6 shows a configuration of a sales promotion support system of Embodiment 2 according to the present invention.

FIG. 7 is a flow chart showing processing in a goods provider server of the sales promotion support system of Embodiment 2 according to the present invention.

FIG. 8 shows a configuration of a sales promotion support system of Embodiment 3 according to the present invention.

FIG. 9 illustrates a computer environment.

### DESCRIPTION OF THE PREFERRED EMBODIMENTS

Embodiment 1

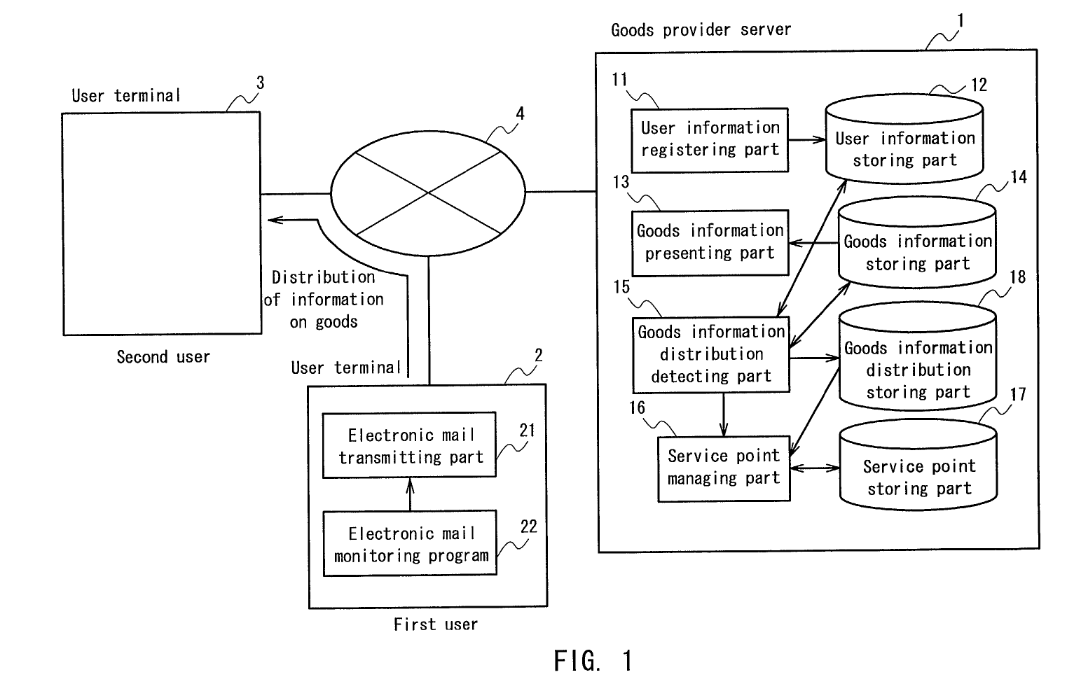

Hereinafter, a sales promotion support system of Embodiment 1 according to the present invention will be described with reference to the drawings. FIG. 1 shows a configuration of the sales promotion support system of Embodiment 1 according to the present invention.

In FIG. 1, reference numeral 1 denotes a goods provider server, 2 denotes a user terminal used by a first user that has first browsed through information on goods provided by the goods provider server 1, and 3 denotes a user terminal used by a second user that has received the information on goods from the first user.

In Embodiment 1, an on-line shopping environment communicable on the Internet will be described. In this case, it is assumed that the goods provider server 1 is a web server, and a browser and software for electronic mail are installed in the user terminals 2 and 3 used by a user.

First, in order to use the on-line shopping environment, it is required that a user registers himself/herself as a member by registering information on himself/herself. The reason for this is to allow the user to accumulate service points for enjoying various services in accordance with the use status

More specifically, the user accesses the goods provider server 1, browses through a web page for member registration, and registers information on the user in a user information storing part 12 by using a user information registering part 11. Herein, examples of information registered in the user information storing part 12 include general items such as a name and an electronic mail address, or biometric information and the like such as fingerprint information. The information registered in the user information storing part 12 is not particularly limited thereto, and any information allowing a user to be identified on a network may be used. A user is provided with a login name and a password by being registered as a member.

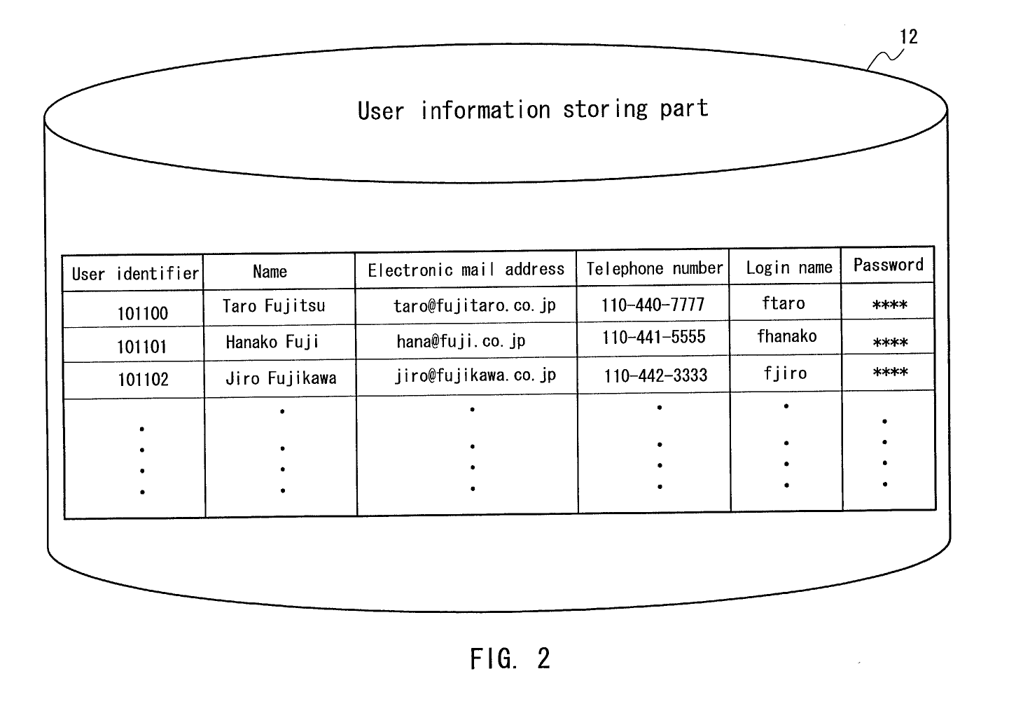

FIG. 2 illustrates the configuration of data registered in the user information storing part 12 in the sales promotion support system of Embodiment 1. As shown in FIG. 2, at least information enabling user to be identified, such as a user identifier to be provided, a name, an electronic mail address, a telephone number, a login name, and a password, is stored in the user information storing part 12.

When required user information is registered, a user-specific user identifier is provided in the user information registering part 11. It is determined whether or not a user is eligible for being provided with a service point and enjoying service in accordance with the number of service points, based on such a user identifier.

Various methods can be considered as a trigger for obtaining a user identifier. For example, a user identifier is sent to the user terminal 2 when user registration is completed in the goods provider server 1 or when a user logs in to a web page.

Next, the first user accesses a web page regarding goods provided by the goods provider server 1 via the Internet 4 from the user terminal 2. By doing so, the first user can obtain information on goods stored in the goods information storing part 14 via the goods information presenting part 13.

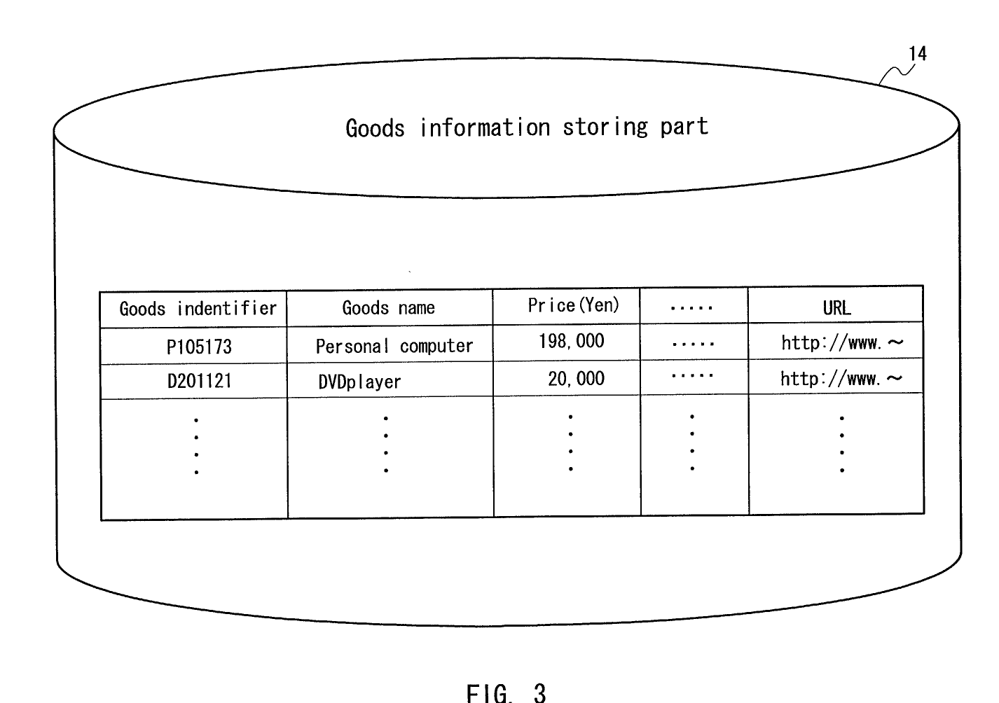

FIG. 3 illustrates the configuration of data of the goods information storing part 14 in the sales promotion support system of Embodiment 1 according to the present invention. As shown in FIG. 3, information on goods at least includes a URL name of a web page on which a user clicks and the like, as well as general goods database items such as a goods identifier, a goods name, and a price. Because of this, the first user can obtain a goods identifier as well as information on goods on a web page.

A goods identifier may be provided, for example, in a URL format so as to be referred to. Needless to say, the provision type of a goods identifier is not particularly limited thereto, and a timing at which a goods identifier is provided is not particularly limited.

As described above, in the case where the first user having browsed through information on goods stored in the goods information storing part 14 through a web page distributes the information on goods through electronic mail, the first user attaches a goods identifier obtained from the goods provider server 1 to the electronic mail. Then, the electronic mail with the goods identifier attached thereto is transmitted to the second user from an electronic mail transmitting part 21.

In order to detect that the information on goods stored in the goods information storing part 14 is obtained, and the information on goods is distributed from the first user to the second user in the goods information distribution detecting part 15, a resident electronic mail monitoring program 22 is also downloaded to the user terminal 2. The electronic mail monitoring program 22 always monitors whether or not a goods identifier is attached to electronic mail to be transmitted. In the case where a goods identifier is attached to electronic mail, the electronic mail monitoring program 22 transmits a user identifier of the first user that is a transmission origin, an electronic mail address of the second user that is a transmission destination, and a goods identifier from the electronic mail transmitting part 21 to the goods information distribution detecting part 15.

The electronic mail monitoring program 22 downloaded from the goods provider server 1 may be a program, for example, for monitoring the state of a mail transmission box and checking whether or not mail containing information on goods in the contents of an attached file has been newly created.

In this case, the format of the mail transmission box is varied depending upon the kind of software for electronic mail used by a user. Therefore, during registration of a user, in the user information registering part 11, software for electronic mail used by the user is also registered in the user information storing part 12, and the electronic mail monitoring program 22 corresponding thereto is downloaded.

In the case where the electronic mail monitoring program 22 detects that electronic mail with information on goods attached thereto has been distributed, the user terminal 2 notifies the goods provider server 1 that distribution of electronic mail has been detected using a user identifier of the first user, an electronic mail address of a transmission destination, and information on goods as parameters.

In addition to the above-mentioned method, there are various methods for detecting the fact that information on goods browsed through by the first user has been distributed to the second user. For example, an electronic mail transmission function is provided to information itself on a web page provided by the goods provider server 1, whereby the fact that information has been browsed through and required information can be transmitted through electronic mail only by a general browsing operation.

Furthermore, it may also be considered that software for electronic mail created by a goods provider is distributed to all the registered users, and distribution of electronic mail with information on goods attached thereto is detected by the software for electronic mail. Because of this, it is not required to provide a monitoring program for each software for electronic mail used by a user.

Furthermore, the following may also be considered. A button of “goods information distribution request” or the like is provided on a web page in the goods provider server 1. When the button is clicked on, software for electronic mail is automatically started, whereby a goods identifier is attached to electronic mail and the goods provider server 1 is notified of distribution of the electronic mail.

In the information distribution detecting part 15 having received a user identifier of the first user that is a transmission origin, an electronic mail address of the second user that is a transmission destination, and a goods identifier (information on goods), service points regarding the first user are updated in a service point managing part 16 based on the transmitted information.

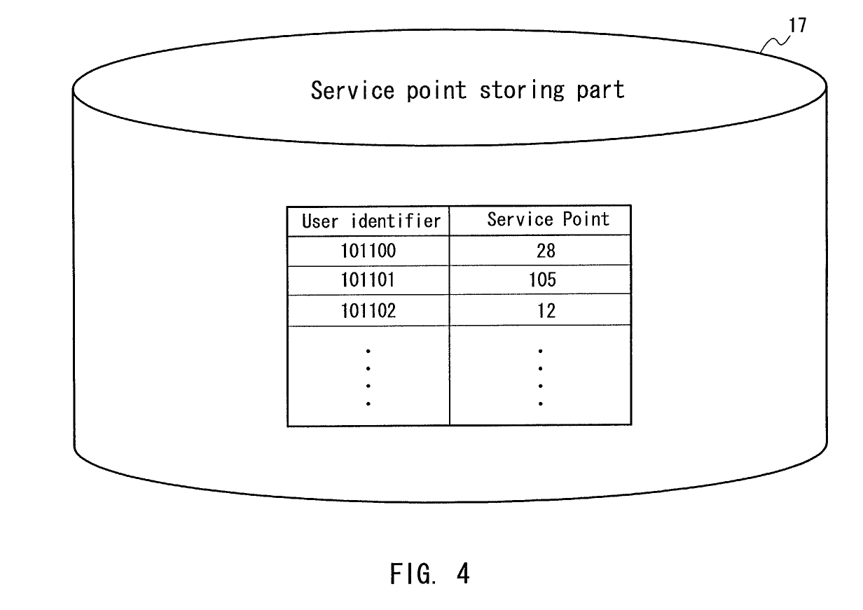

FIG. 4 illustrates the configuration of data of a service point storing part 17 to be managed by a service point managing part 16 in the sales promotion support system of Embodiment 1 according to the present invention. As shown in FIG. 4, in the service point storing part 17, an accumulation value of the number of service points is recorded on the user identifier basis.

Regarding the above-mentioned user identifier and goods identifier, forging and alteration of information by a malicious third party may be prevented in advance by encryption or the like. Because of this, made-up transaction by pretending or the like can be prevented.

Furthermore, regarding a user identifier, it may also be considered that when a goods provider server is accessed, correctness of a user identifier can be determined. More specifically, when a user identifier is provided, the user information registering part 11 attaches an electronic transparency to the user identifier so that access using a user identifier created by a third party without authorization can be clearly discriminated. Because of this, unauthorized obtaining of service points as well as unauthorized purchase activities using a forged user identifier can be prevented.

Furthermore, regarding a goods identifier, it may also be considered that when a goods provider server is accessed, correctness of a goods identifier can be determined. More specifically, when information on goods is stored in the goods information storing part 14, an electronic transparency or the like is also attached to a goods identifier so that access using a user identifier created by a third party without authorization can be clearly discriminated. Because of this, unauthorized obtaining of service points as well as unauthorized purchase activities using a forged goods identifier can be prevented.

In addition, it may also be considered that in the case where distribution from the first user to the second user is conducted a plurality of times, service points are not updated at a time of the second and subsequent distributions. More specifically, a goods information distribution storing part 18 is provided, and a user identifier of the first user that is transmitted at a time of distribution of information on goods, an electronic mail address of the second user, and a goods identifier are stored in the goods information distribution storing part 18. The service point managing part 16 refers to the goods information distribution storing part 18 at a time of update of service points, and prevents service points from being updated in the case where the contents of distribution have already been stored in the goods information distribution storing part 18. This enables the same person from updating service points by a plurality of operations without authorization.

Furthermore, the following may also be considered. It is confirmed whether or not an electronic mail address of the second user is stored as that of another user in the user information storing part 12, whereby unauthorized obtaining of service points merely by transferring information on goods to another electronic mail address owned by the same user.

Furthermore, in order to enhance an incentive for purchase of goods, service points of the second user to which information on goods has been distributed may be updated. In this case, it is required that the second user is registered before distribution of information from the first user, and when an electronic mail address of the second user is received in the goods information distribution detecting part 15, the user information storing part 12 is referred to, whereby a user identifier to which a service point should be given is extracted. In the service point managing part 16, service points equal to those of the first user are also given to a user identifier of the second user. Because of this, the second user to which information on goods has been distributed can be given an incentive for purchase of the goods. As a result, an increase in transaction can be expected.

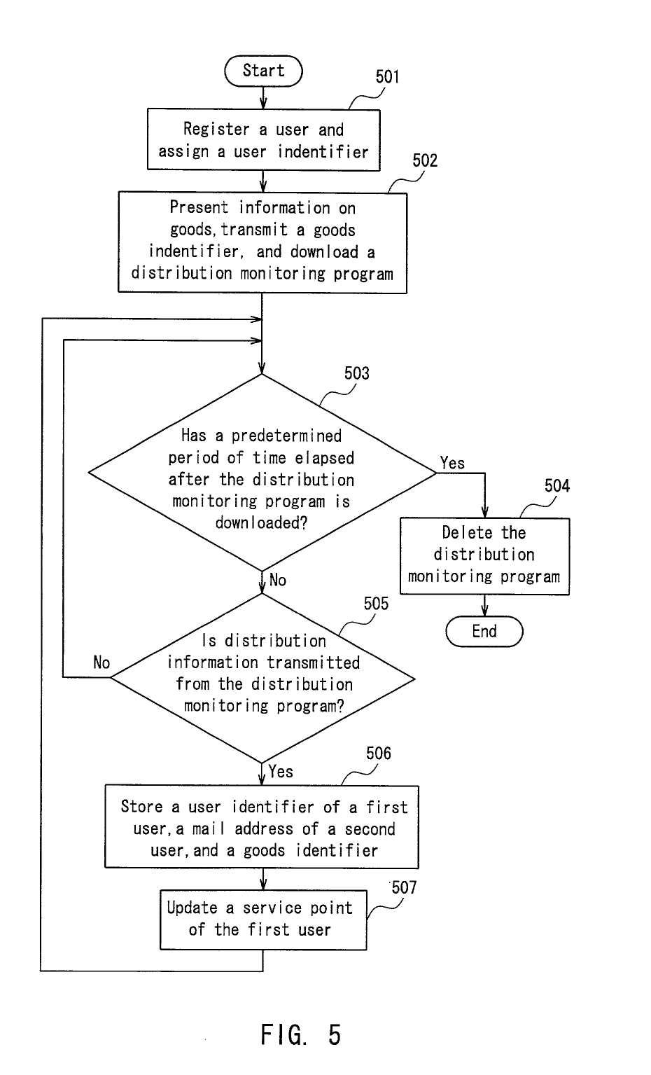

Next, a processing flow of a program in the goods provider server 1 for realizing the sales promotion support system of Embodiment 1 according to the present invention will be described. FIG. 5 is a flow chart showing processing of a program in the goods provider server 1 for realizing the sales promotion support system of Embodiment 1 according to the present invention. The case where a distribution monitoring program is deleted after an elapse of a predetermined period of time will be described. Needless to say, postprocessing of the distribution monitoring program is not particularly limited thereto.

Referring to FIG. 5, first, information on a user is registered (Operation 501), and a user identifier is assigned to a user eligible for enjoying benefits of the service. Then, information on goods is presented (provided) to a first user that accesses the information on goods, a goods identifier is transmitted to the first user, and a distribution monitoring program is downloaded to the user terminal 2 of the first user (Operation 502).

The distribution monitoring program is operated until a predetermined period of time elapses after the distribution monitoring program is downloaded from the goods provider server 1 to the user terminal 2 used by the first user (Operation 503). In the case where a predetermined period of time elapses after downloading (Operation 503: Yes), the distribution monitoring program is deleted (Operation 504).

When distribution information is transmitted from the distribution monitoring program (Operation 505: Yes), a user identifier of the first user, an electronic mail address of the second user, and a good identifier are recorded (Operation 506), and service points of the first user are updated (Operation 507). Such processing is repeated while the distribution monitoring program is operated.

As described above, in Embodiment 1, even in the case where the first user having browsed through information on goods distributes the information to the second user as word-of-mouth information, a service point is given as an incentive to the first user that is a distribution origin, which promotes distribution of the information on goods. As a result, it is expected that a purchase chance by a third party is increased.

Embodiment 2

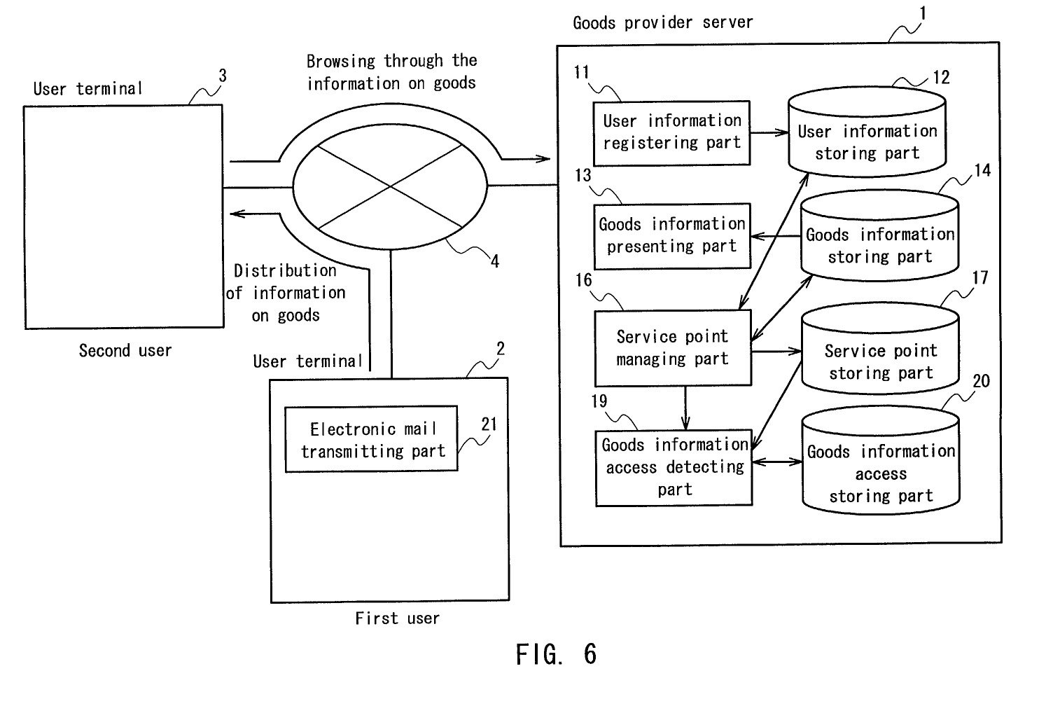

Hereinafter, a sales promotion support system of Embodiment 2 according to the present invention will be described with reference to the drawings. FIG. 6 shows the configuration of the sales promotion support system of Embodiment 2 according to the present invention.

In FIG. 6, in the same way as in FIG. 1, reference numeral 1 denotes a goods provider server, 2 denotes a user terminal used by a first user that has first browsed through information on goods provided by the goods provider server 1, and 3 denotes a user terminal used by a second user that has received the information on goods from the first user.

In the same way as in Embodiment 1, in order to use the on-line shopping environment, it is required that a user should be registered as a member or the like, and the first user obtains information on goods by accessing a web page regarding goods provided by the goods provider server 1 from the user terminal 2 via the Internet 4.

The difference from Embodiment 1 lies in that a user identifier of the first user is included in formation of goods obtained by accessing a web page and a goods information access detecting part 19 is provided for the purpose of detecting access of the second user to the goods provider server 1 based on the information on goods distributed from the first user to the second user. The goods information access detecting part 19 monitors all the users accessing the information on goods to be provided, and determines whether or not a user identifier is included in access information.

More specifically, in the case where the first user attaches information on goods to electronic mail transmitted to the second user in the form of an attached file, an icon, or the like, a user identifier of the first user may be included in a URL name presenting the information on goods. Because of this, in order to browse through the information on goods based on the transmitted electronic mail, the second user clicks on the attached file or icon having a URL name including the user identifier of the first user. More specifically, there are a plurality of web pages that have the same contents as those of information on goods first browsed through by the first user and are different from each other only in user identifiers.

The goods information access detecting part 19 detects access to a web page having a URL name including a user identifier of the first user, whereby the transmission origin of the information on goods can be confirmed to be a first user, and service points of the first user are updated in the service point managing part 16.

Needless to say, in the same way as in Embodiment 1, whether or not a user identifier and a goods identifier are generated with authorization may be determined. The purpose of this is to prevent service points from being updated by an unauthorized operation in advance.

Furthermore, the second user to which information on goods is distributed from the first user may be registered as a member or the like, or may not be registered as such. In the case where the second user is not registered, it is preferable that the second user is registered as a member or the like when the second user clicks information on goods attached to the transmitted electronic mail to access a web page on the goods provider server 1.

Because of this, a higher incentive is given to an action of the second user's access to a web page based on the information on goods, as well as distribution of information on goods from the first user to the second user, whereby it becomes possible to promote selective distribution of information on goods with respect to users who are more interested in the goods.

Furthermore, a goods information access storing part 20 may be provided, which records whether or not the second user has accessed the goods provider server 1 based on the information on goods, with respect to each second user to which the information on goods has been distributed from the first user. More specifically, regarding the second user that is recorded to have accessed the goods information access storing part 20, service points will not be updated even if the second user attempts to access the goods information access storing part 20 thereafter. Because of this, the second user is prevented from conducting an unauthorized action of updating only service points by accessing the information on goods which the second user has already accessed by browsing or the like.

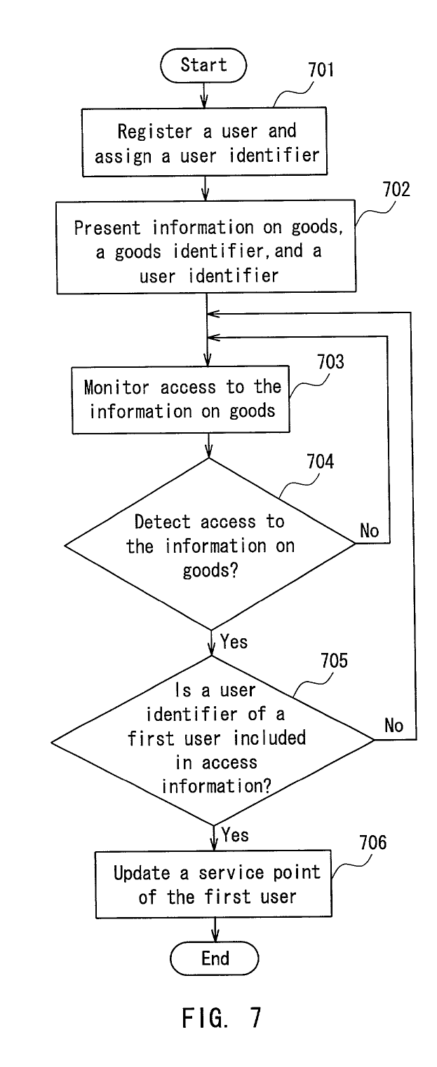

Next, a processing flow of a program in the goods provider server 1 for realizing the sales promotion support system of Embodiment 2 according to the present invention will be described. FIG. 7 is a flow chart showing processing of a program in the goods provider server 1 for realizing the sales promotion support system of the present embodiment according to the present invention.

Referring to FIG. 7, first, information on a user is registered (Operation 701), and a user identifier is assigned to a user eligible for enjoying benefits of the service. Then, information on goods is presented (provided) to a first user that accesses the information on goods, a goods identifier and the information on goods including a user identifier of the first user are transmitted to the first user (Operation 702).

After the first user transmits the goods identifier and the information on goods provided with a user identifier of the first user to the second user, access of the second user to the goods provider server 1 based on the goods identifier transmitted from the first user is monitored (Operation 703).

Next, when a user different from the first user, accessing the information on goods, is detected (Operation 704: Yes), it is confirmed whether or not the user identifier of the first user is included in the access information (Operation 705). If the user identifier of the first user is included in the access information (Operation 705: Yes), the access can be determined to be based on the information distributed from the first user that has first browsed through the information on goods, so that service points of the first user are updated (Operation 706).

As described above, in Embodiment 2, even in the case where after the first user having browsed through the information on goods distributes the information as word-of-mouth information to the second user, the second user browses through the information on goods based on the distributed information, a service point is given as an incentive to the first user that is a transmission origin, which can further promote distribution of information on goods. As a result, it is expected that a purchase chance by a third party can be increased.

Embodiment 3

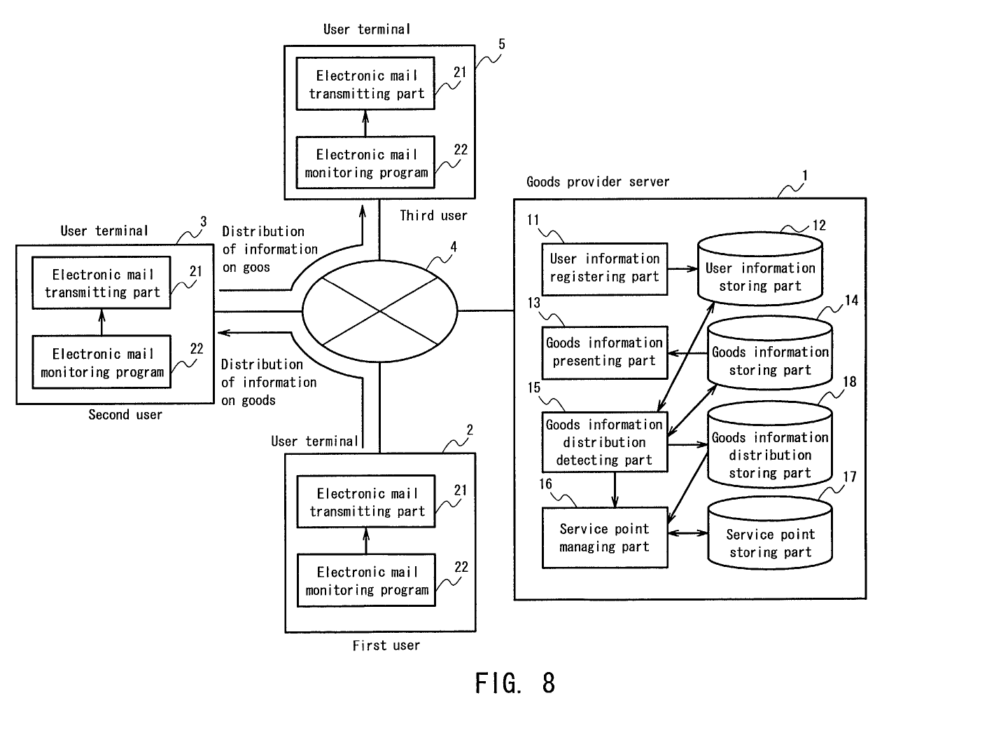

Hereinafter, a sales promotion support system of Embodiment 3 according to the present invention will be described with reference to the drawings. FIG. 8 shows the configuration of the sales promotion support system of Embodiment 3 according to the present invention.

In FIG. 8, reference numeral 1 denotes a goods provider server, 2 denotes a user terminal used by a first user having browsed through information on goods provided by the goods provider server 1, 3 denotes a user terminal used by a second user that has received the information on goods from the first user, and 5 denotes a user terminal used by a third user that has received information on goods from the second user.

In Embodiment 3, update of service points in the case where the second user transfers mail to the third user will be described. More specifically, the second user browses through information on goods in the goods provider server 1 based on information on goods attached to electronic mail transmitted from the first user, and further distributes the information on goods to the third user.

Herein, in the case where the second user is registered, the fact that the second user has distributed information on goods to the third user can be detected by the same method as that in the case of distribution from the first user in Embodiment 1, and service points of the second user can be updated.

However, according to the method of Embodiment 2, since information on goods including a user identifier of the first user is distributed to the third user, service points are not given to the second user, and an incentive for promoting distribution to another user is not given to the second user that is a direct distributor.

In order to solve this problem, when the goods provider server 1 detects that information on goods has been distributed from the first user (distribution origin) to the third user, a communication path in which information on goods is transferred from the first user to the third user is confirmed in the goods information distribution recording part 18.

More specifically, in the same way as in Embodiment 1, the electronic mail distribution monitoring program 22 is downloaded to the second user or the third user that is a distribution destination, as well as the first user that is a distribution origin, and every time information on goods is distributed to another user through electronic mail or the like, the goods information distribution detecting part 15 stores user identifiers of a distribution origin and a distribution destination in the goods information distribution storing part 18.

In processing, it is considered that the electronic mail monitoring program 22 is not required at the user terminal 5 used by the third user. However, it is required to detect that the third user further distributes information on goods to another user. Therefore, when the goods provider server 1 detects distribution through electronic mail, the electronic mail monitoring program 22 is simultaneously downloaded to each user terminal.

In the case where the second user that is a distribution mediator is present while information on goods is distributed from the first user to the third user, service points are also given to the second user. The second user may be one user, or a plurality of users.

Because of this, more service points are given to the second user that is a distribution mediator of information, which is desirable in terms of promoting distribution of information.

As described above, in Embodiment 3, service points are also given to a user that indirectly mediates information on goods. Therefore, an incentive for promoting distribution of information on goods can be given to a user, and it can be expected that a purchase chance by a third party is increased.

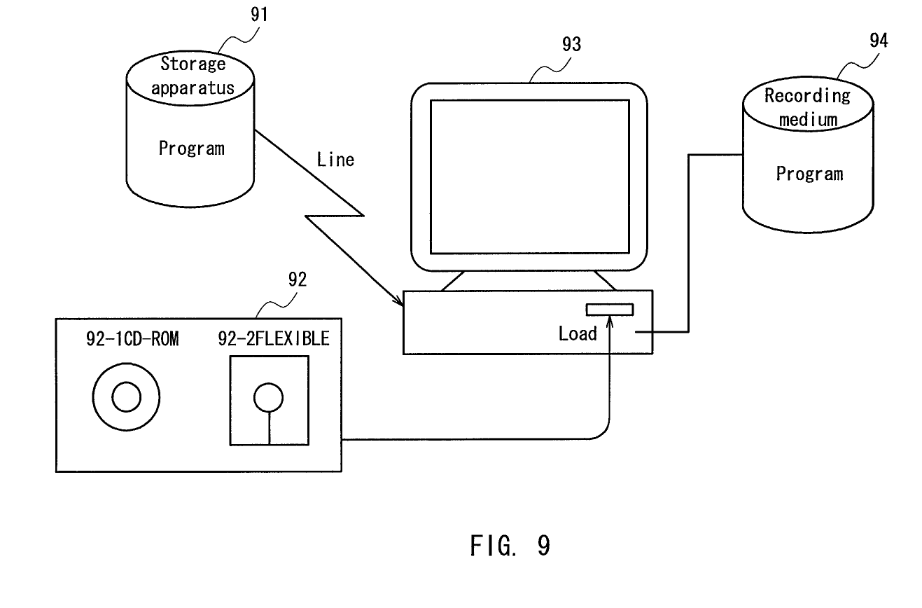

A program for realizing the sales promotion support system of the embodiments according to the present invention may be stored in a storage apparatus 91 provided at the end of a communication line and a recording medium 94 such as a hard disk and a RAM of a computer 93, as well as a portable recording medium 92 such as a CD-ROM 92-1 and a flexible disk 92-2, as shown in FIG. 9. In execution, the program is loaded and executed on a main memory.

Furthermore, user information, service points, and the like generated by the sales promotion support system of the embodiments according to the present invention may also be stored in a storage apparatus 91 provided at the end of a communication line and a recording medium 94 such as a hard disk and a RAM of a computer 93, as well as a portable recording medium 92 such as a CD-ROM 92-1 and a flexible disk 92-2, as shown in FIG. 9. For example, such a storage apparatus and a recording medium are read by a computer 93 when the sales promotion support system of the present invention is utilized.

As described above, according to the sales promotion support system of the present invention, even in the case where a first user having browsed through information on goods distributes the information to a second user as word-of-mouth information or in the case where after a first user having browsed through information on goods distributes the information to a second user as word-of-mouth information, a second user browses through information on goods based on the distributed information, service points are given as an incentive to the first user that is a distribution origin, which promotes distribution of information on goods. As a result, it can be expected that a purchase chance by a third party is increased.

Furthermore, service points are also given to a user that indirectly mediates information on goods, so that an incentive can be given to a user so as to promote distribution of information on goods, and it can be expected that a purchase chance by a third party is increased.

The invention may be embodied in other forms without departing from the spirit or essential characteristics thereof. The embodiments disclosed in this application are to be considered in all respects as illustrative and not limiting. The scope of the invention is indicated by the appended claims rather than by the foregoing description, and all changes which come within the meaning and range of equivalency of the claims are intended to be embraced therein.

What is claimed is:

1. A sales promotion support system in an on-line shopping environment in which a goods provider server used by a goods provider that provides goods is connected to a user terminal used by a user through a communication path,
the goods provider server comprising:
a user information registering part for registering information on the user;
a goods information presenting part for presenting information on goods to the user;
a service point managing part for managing service points given on a basis of a user registered in the user information registering part; and
a goods information distribution detecting part for detecting that a first user having browsed through the information on goods at the user terminal has distributed the information on goods to a second user,
wherein, in a case where it is detected by the goods information distribution detecting part that the information on goods has been distributed to the second user, the service points of the first user are updated in the service point managing part.

2. A sales promotion support system in an on-line shopping environment in which a goods provider server used by a goods provider that provides goods is connected to a user terminal used by a user through a communication path,
the goods provider server comprising:
a user information registering part for registering information on the user;
a goods information presenting part for presenting information on goods to the user;
a service point managing part for managing service points given on a basis of a user registered in the user information registering part; and
a goods information access detecting part for detecting that a second user has accessed the goods provider server, based on the information on goods distributed to the second user by a first user having browsed through the information on goods at the user terminal,
wherein, in a case where it is detected by the goods information access detecting part that the second user has accessed the goods provider server based on the information on goods distributed from the first user, the service points of the first user having distributed the information on goods are updated in the service point managing part.

3. A sales promotion support system according to claim 2, wherein when the service points of the first user are updated in the service point managing part, the service points of the second user are simultaneously updated in the service point managing part.

4. A sales promotion support system according to claim 2, wherein the information on goods contains information allowing the first user to be confirmed as a distribution origin.

5. A sales promotion support system according to claim 3, wherein the information on goods contains information allowing the first user to be confirmed as a distribution origin.

6. A sales promotion support system according to claim 4, wherein a user identifier specific for a user is provided, and the information allowing the first user to be confirmed as a distribution origin contains the user identifier.

7. A sales promotion support system according to claim 5, wherein a user identifier specific for a user is provided, and the information allowing the first user to be confirmed as a distribution origin contains the user identifier.

8. A sales promotion support system according to claim 4, wherein a goods identifier specific for goods is provided, and the information on goods contains the goods identifier.

9. A sales promotion support system according to claim 5, wherein a goods identifier specific for goods is provided, and the information on goods contains the goods identifier.

10. A sales promotion support system according to claim 1, further comprising a goods information distribution storing part for storing the user identifier of the first user, the user identifier of the second user, and the goods identifier, when the first user distributes the information on goods to the second user,
wherein regarding second and subsequent distributions having the same identifiers as the user identifier of the first user, the user identifier of the second user, and the goods identifier stored in the goods information distribution storing part, the service points are not updated.

11. A sales promotion support system according to claim 1, further comprising a goods information access storing part for storing the user identifier of a user having accessed the information on goods and the goods identifier so that they are associated with each other
wherein regarding the second user whose user identifier has already been stored in the goods information access storing part with respect to a predetermined goods identifier, the service points are not updated.

12. A sales promotion support system according to claim 2, further comprising a goods information access storing part for storing the user identifier of a user having accessed the information on goods and the goods identifier so that they are associated with each other
wherein regarding the second user whose user identifier has already been stored in the goods information access storing part with respect to a predetermined goods identifier, the service points are not updated.

13. A sales promotion support system according to claim 3, further comprising a goods information access storing part for storing the user identifier of a user having accessed the information on goods and the goods identifier so that they are associated with each other
wherein regarding the second user whose user identifier has already been stored in the goods information access storing part with respect to a predetermined goods identifier, the service points are not updated.

14. A sales promotion support system according to claim 1, further comprising a user authentication procedure part for authenticating whether or not the user has already been registered in the user information registering part,
wherein the service points are updated only with respect to a user confirmed to be registered in the user authentication procedure part.

15. A sales promotion support system according to claim 10, wherein, in a case where a third user accesses the information on goods browsed through by the first user via one or a plurality of the second users, a distribution path in which the information on goods is distributed from the first user to the third user is derived based on distribution information in the goods information distribution storing part, and the service points are updated with respect to the second user present in the distribution path.

16. A sales promotion support method in an on-line shopping environment in which a goods provider server used by a goods provider that provides goods is connected to a user terminal used by a user through a communication path,
the goods provider server comprising:
registering information on the user;
presenting information on goods to the user;
managing service points given on a basis of a registered user; and
detecting that a first user having browsed through the information on goods at the user terminal has distributed the information on goods to a second user,
wherein, in a case where it is detected that the information on goods has been distributed to the second user, the service points of the first user are updated.

17. A sales promotion support method in an on-line shopping environment in which a goods provider server used by a goods provider that provides goods is connected to a user terminal used by a user through a communication path,
the goods provider server comprising:
registering information on the user;
presenting information on goods to the user; and
managing service points given on a basis of a registered user; and
detecting that the second user has accessed the goods provider server based on the information on goods distributed from the first user having browsed through the information on goods at the user terminal to the second user,
wherein, in a case where it is detected that the second user has accessed the goods provider server based on the information on goods distributed from the first user, the service points of the first user having distributed the information on goods are updated.

18. A sales promotion support method according to claim 16, wherein when the service points of the first user are updated, the service points of the second user are simultaneously updated.

19. A sales promotion support method according to claim 17, wherein when the service points of the first user are updated, the service points of the second user are simultaneously updated.

20. A computer-readable recording medium storing a program executed in a goods provider server for implementing a sales promotion support method in an on-line shopping environment in which a goods provider server used by a goods provider that provides goods is connected to a user terminal used by a user through a communication path, comprising:
registering information on the user;
presenting information on goods to the user;
managing service points given on a registered user basis; and
detecting that a first user having browsed through the information on goods at the user terminal has distributed the information on goods to a second user,
wherein, in a case where it is detected that the information on goods has been distributed to the second user, the service points of the first user are updated.

21. A computer-readable recording medium storing a program executed in a goods provider server for implementing a sales promotion support method in an on-line shopping environment in which a goods provider server used by a goods provider that provides goods is connected to a user terminal used by a user through a communication path, comprising:
registering information on the user;
presenting information on goods to the user;
managing service points given on a registered user basis; and
detecting that a second user has accessed the goods provider server, based on the information on goods distributed to the second user by a first user having browsed through the information on goods at the user terminal,
wherein, in a case where it is detected that the second user has accessed the goods provider server based on the information on goods distributed from the first user, the service points of the first user having distributed the information on goods are updated.

22. A computer-readable recording medium storing a program executed by a computer according to claim 20, wherein when the service points of the first user are updated, the service points of the second user are simultaneously updated.

23. A computer-readable recording medium storing a program executed by a computer according to claim 21, wherein when the service points of the first user are updated, the service points of the second user are simultaneously updated.
